(19) United States
(12) Patent Application Publication
(10) Pub. No.: US 2006/0259456 A1
(43) Pub. Date: Nov. 16, 2006

(54) System for describing text file formats in a flexible, reusable way to facilitate text file transformations

(76) Inventors: Alexander Falk, Marblehead, MA (US); Vladislav Gavrielov, Wien (AT)

Correspondence Address: HOLLAND & KNIGHT LLP, 10 ST. JAMES AVENUE, BOSTON, MA, 02116, US

(21) Appl. No.: 11/125,532

(22) Filed: May 10, 2005

(51) Int. Cl. G06F 17/30

(52) U.S. Cl. 707/2

(57) ABSTRACT

A text file schema enables any text file to be expressed as an XML or database format, or vice versa. The text file may be simple (e.g., binary data, comma separated values, tab separated values, or the like) or complex (basic EDI files, UN/EDIFACT, ANSI X.12 EDI, or the like). With the present invention, a text file format is expressed as a set of external files that define the file format in a flexible, reusable way. The external files preferably conform to a given XML schema. They enable the text file format to be used across data integration mapping projects and, in particular, to facilitate transformation of data contained in text files (that conform to the file format) from/to other data formats. Preferably, the external files comprise a first external file that describes the text file configuration according to the schema, a second external file that describes the structure of the text file according to the schema, and a third external file that describes control data of the text file according to the schema.

### COPYRIGHT NOTICE

This application includes subject matter protected by copyright. All rights are reserved.

### BACKGROUND OF THE INVENTION

1. Technical Field

The present invention relates generally to legacy data integration and, in particular, to techniques for describing text file formats in a flexible, reusable way to facilitate transformation of the data contained in such text files from/to other data formats.

2. Description of the Related Art

Organizations today are realizing substantial business efficiencies in the development of data intense, connected, software applications that provide seamless access to database systems within large corporations, as well as externally linking business partners and customers alike. Such distributed and integrated data systems are a necessary requirement for realizing and benefiting from automated business processes, yet this goal has proven to be elusive in real world deployments for a number of reasons including the myriad of different database systems and programming languages involved in integrating today's enterprise back-end systems

Internet technologies in particular have given organizations the ability to share information in real-time with customers, partners, and internal business units. These entities, however, often store and exchange data in dissimilar formats, such as XML, databases, and legacy EDI systems. To remain competitive, today's companies must have the ability to seamlessly integrate information regardless of its underlying format. One simple text file format is a “flat file.” Flat files such as CSV (comma separated value) and text documents are supported by many different applications and are often used as an exchange format between dissimilar programs. The ability to programmatically integrate flat file data with other prevalent data formats is a common requirement, but one that has not been readily addressed in existing data integration tools.

It would be desirable to extend the functionality of such known data integration tools to provide text file support and, in particular, to facilitate text file format to XML (or database) transformation, or vice versa. The present invention addresses this need.

### BRIEF SUMMARY OF THE INVENTION

It is a general object of the invention to provide a data integration tool with support for text files as both the source and target of a given data integration mapping project.

A more specific object of the invention is to provide techniques for describing text file formats in a flexible, reusable way to facilitate transformation of the data contained in such text files from and to other data formats.

Another specific object of the invention to provide a system and method that enables a user to describe text file formats in a flexible way that defines what data is contained in the text file, how it is structured and what type of data it is, and how that description can be used to transform such text files into other data formats, such as databases, or XML, and also to transform other data into such text files according to the described format.

Another object of the invention is to provide an extensible framework for describing text file formats so that any existing format (whether simple or complex) can be imported into or exported from a data integration project, as well as to enable a user to define new or custom flat file formats.

It is yet another more specific object of the invention to provide the ability to programmatically integrate text file data with other prevalent data formats.

A text file schema enables any text file to be converted to an XML or database format, or vice versa. The text file may be simple (e.g., binary data, comma separated values, tab separated values, or the like) or complex (basic EDI files, UN/EDIFACT, ANSI X.12 EDI, or the like). With the present invention, the definition of a text file format is expressed as a set of external files that define the file format in a flexible, reusable way. The external files preferably conform to a given XML schema. They enable the text file format to be used across data integration mapping projects and, in particular, to facilitate transformation of data contained in text files (that conform to the file format) from/to other data formats. Preferably, the external files comprise a first external file that describes the text file configuration according to the schema, a second external file that describes the structure of the text file according to the schema, and a third external file that describes control data of the text file according to the schema.

The text file schema may be used to take an existing set of text file messages (such as a set of standards-based messages) and to generate a set of external files that may then be prepackaged with a data integration mapping tool. In another embodiment, a display tool may be used to enable a user to specify a custom text file format, which is then converted into its own set of corresponding external files.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a data processing system in which the present invention may be implemented;

FIG. 2 illustrates a known data integration tool that has been modified to provide text file support according to the present invention;

FIG. 3 illustrates a display from which a user can select for mapping one of a set of supported EDI messages;

FIG. 4 illustrates a mapping design window of an integration tool and the use thereof to map an XML message to an EDI message;

FIG. 5 illustrates a set of external files that are created according to an XML schema for a given text file format according to the present invention;

FIG. 6 illustrates a Generator element of the XML schema;

FIG. 7 illustrates a Meta element of the XML schema;

FIG. 8 illustrates a Scanner element of the XML schema;

FIG. 9 illustrates a Parser element of the XML schema;

FIG. 10 illustrates an Output element of the XML schema;

FIG. 11 illustrates a representative EDI file prior to processing according to the present invention;

FIG. 12 illustrates a representative external configuration file generated from the EDI file of FIG. 11;

FIG. 13 illustrates a representative portion of the external structure file generated from the EDI file of FIG. 11; and

FIG. 14 illustrates a representative portion of the external control file generated from the EDI file of FIG. 11.

### DETAILED DESCRIPTION

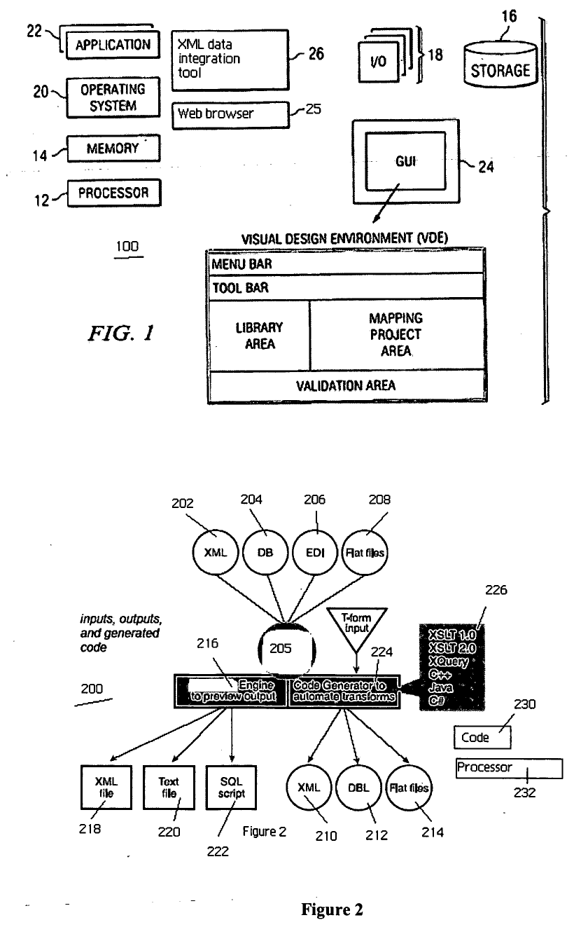

The present invention is implemented in a data processing system such as shown in FIG. 1. Typically, a data processing system 100 is a computer having one or more processors 12, suitable memory 14 and storage devices 16, input/output devices 18, an operating system 20, and one or more applications 22. One input device is a display 24 that supports a window-based graphical user interface (GUI). The data processing system includes suitable hardware and software components (not shown) to facilitate connectivity of the machine to the public Internet, a private intranet or other computer network. In a representative embodiment, the data processing system 100 is an Intel commodity-based computer executing a suitable operating system such as Windows NT, 2000, or XP. Of course, other processor and operating system platforms may also be used. The data processing system includes a Web browser 25 and an XML data integration tool 26. A representative XML data integration tool 26 is MapForce® from Altova. An XML integration tool provides a design interface for mapping between pairs of data representations (e.g., between XML, EDI or database data, and XML and/or databases, on the other), and it may also auto-generate mapping code for use in custom data integration applications. An integration tool of this type enables an entity to map its internal data representations into formats that match those of third parties, may include ancillary technology components such as: an XML parser, an interpreter engine, an XSLT processor, and the like. These components may be provided as native applications within the XML tool or as downloadable components.

According to the present invention, the data integration tool is supplemented to provide support for converting text files to XML or databases, and vice versa. FIG. 2 illustrates the high level functionality of a data integration tool 200. The tool provides a display interface 205 for mapping (in this illustrated example) any combination of XML 202, database 204, EDI 206 or flat file 208, to XML 210, databases 212 or flat files 214. The tool may also include given software code (a set of instructions) that functions as an engine 216 for previewing outputs, such as an XML file 218, a text file 220, or an SQL script 222. A code generator 224 auto-generates mapping code 226 for use in custom data integration applications. The display interface 205, preview engine 216 and code generator 224 functions are described in co-pending application Ser. No. 10/844,985, titled “METHOD AND SYSTEM FOR VISUAL DATA MAPPING AND CODE GENERATION TO SUPPORT DATA INTEGRATION,” the disclosure of which is incorporated herein by reference. As will be described below, the present invention may be implemented in a known data integration tool of this type. In particular, and with reference to FIG. 2, the data integration tool includes code 230 executable by a processor 232 for describing a text file into an alternative structured representation of the text file, wherein the alternative representation conforms to a given XML schema that defines what data is contained in the text file, how the text file is structured, and how the text file can be transformed into at least one other non text file format.

The present invention will now be described in more detail using EDI text file formats as representative. As described above, EDI formats are relatively complex, but the techniques of the present invention are applicable to any text file format. By way of additional background, EDI (Electronic Data Interchange) is a widely-used, standard format for exchanging information electronically between information systems. There are several EDI standards in use today, the most prevalent being ANSI X12 and UN/EDIFACT. ANSI (American National Standards Institute) X12 has become the de facto EDI standard in the US as well as much of North America, while UN/EDIFACT (United Nations Electronic Data Interchange for Administration Commerce and Transport) is the most prevalent international EDI standard. The use of EDI has allowed organizations across diverse industries to increase efficiency and productivity by exchanging large amounts of information with trading partners and other companies electronically, in a quick, standardized way. However, as organizations that utilize EDI increasingly use the Internet to exchange information with customers and partners, the challenge has become integrating data from EDI sources with other common content formats, such as databases, XML, CSV or text files, and other EDI systems to enable efficient interconnected e-business applications. Previously, EDI integration could be a time-consuming, costly process.

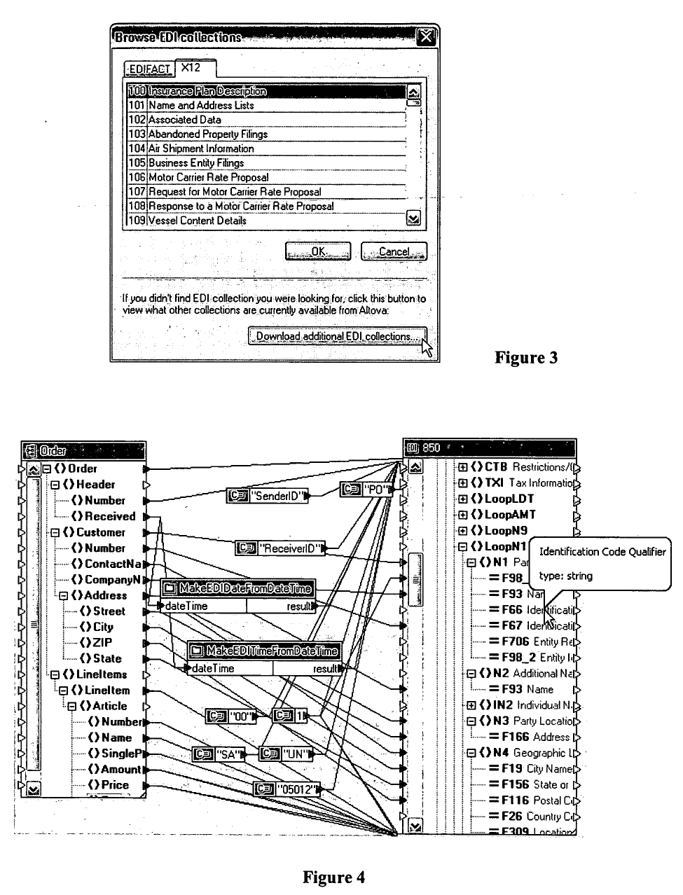

A user browses a list of supported EDI messages from a display, e.g., as illustrated in FIG. 3. Preferably, and as will be described in more detail below, each EDI message identified in the directory is modeled by a set of external files (a configuration file, a structure file, and a control file). To develop a mapping, two or more data structures are loaded into the design window, the tool represents their hierarchical structure visually, and the user can then map the data structures by dragging connecting lines between matching elements in the source(s) and target(s) and inserting data processing rules. In particular, as a mapping is being developed, and as described in Ser. No. 10/844,985, the system may also provide a library of data processing functions for filtering data based on Boolean conditions or manipulating data between the source and target. Once the data mappings and data processing functions are defined, the data integration tool auto-generates the software program code required to programmatically marshal data from the source to the target content model for use in the customized data integration application. Using auto-generated code ensures compatibility and interoperability across different platforms, servers, programming languages and database environments. As also described in Ser. No. 10/844,985, preferably the engine allows execution and viewing of the output of a mapping at any time. Using this data integration tool (as supplemented by the present invention), mappings to a target XML Schema produce an XML instance document, while mappings to flat files have output in CSV or fixed-length text files, and mappings to EDI produce either EDIFACT messages or X12 transaction sets, depending upon which standard is chosen. Mappings to a database produce output in the form of SQL scripts (e.g., SELECT, INSERT, UPDATE and DELETE statements), which can be edited on the fly and run against a target database directly from within the system.

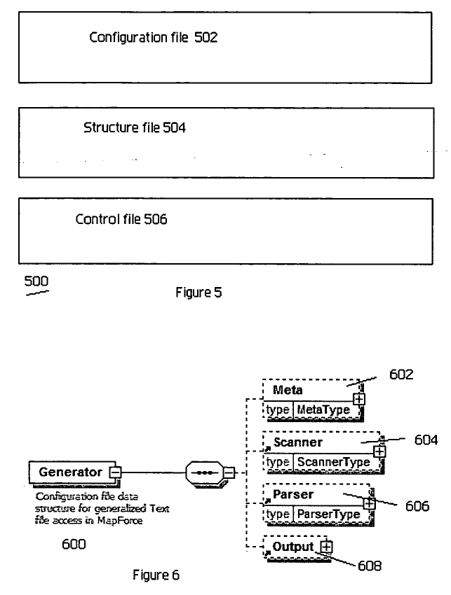

Generalizing, a text data file format upon which the present invention operates is a collection of data records having minimal or no structure. A text data file may be simple or complex. Examples of simple text files include, without limitation, binary data, text files, flat files, CSV values, and tab-separated files. Examples of complex text data files include, without limitation, basic EDI files, standards-based EDI files such as UN/EDIFACT, ANSI X.12, and the like. The present invention is not limited to any particular text file format, but rather provides an extensible solution for any known (legacy) or later-developed text file format. Unlike a database, typically a text file (whether simple or complex) contains only data, and no structural information, such as metadata, that defines a structure. Thus, for example, a flat file is usually a simple arrangement of data elements that stores descriptive information about the data within the file itself. Information in the flat file usually is expressed in the form of a character string. More generally, a text file that may be the described by the schema of the present invention is a file that does not include formatting. According to the invention, a given text file description is associated with a set of files according to an XML schema that is now described in detail. The files may be pre-packaged and distributed with a set of EDI-related tools, or they may be created manually using an XML editor. These files are sometimes referred to as “external” files because they are not written into the data integration application directly. The external files define an extensible framework or schema that describes the text file format in a flexible, reusable way to facilitate transformation of the data contained in the text file from/to other data formats. In this way, the present invention provides a text file schema that may be incorporated in an existing data integration tool. The set of external files, in effect, impose a structure on a given text file format where one does not necessarily exist. According to a preferred embodiment, a set of external files 500 are illustrated in FIG. 5 and preferably include a configuration file 502, a structure file 504, and a control file 506. Each of the files preferably is formatted in XML (according to an XML schema) and includes text file data entered in a convenient manner, e.g., through use of appropriate display panels. One of ordinary skill, of course, will appreciate that the use of separate configuration, structure and control files is not a limitation of the invention.

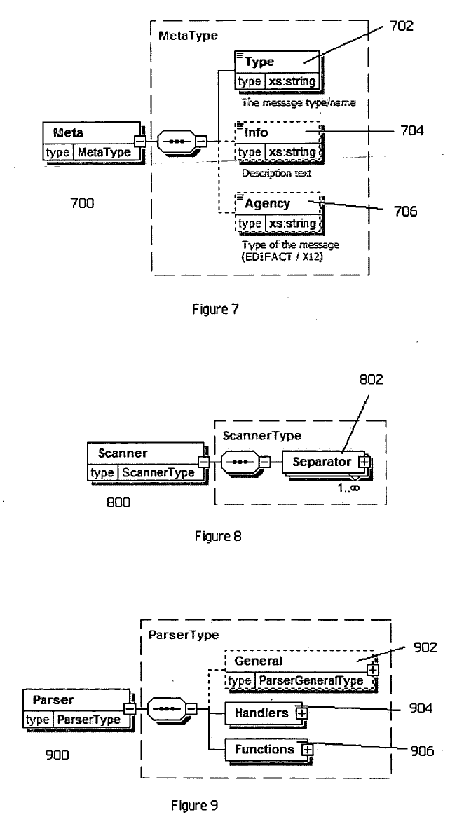

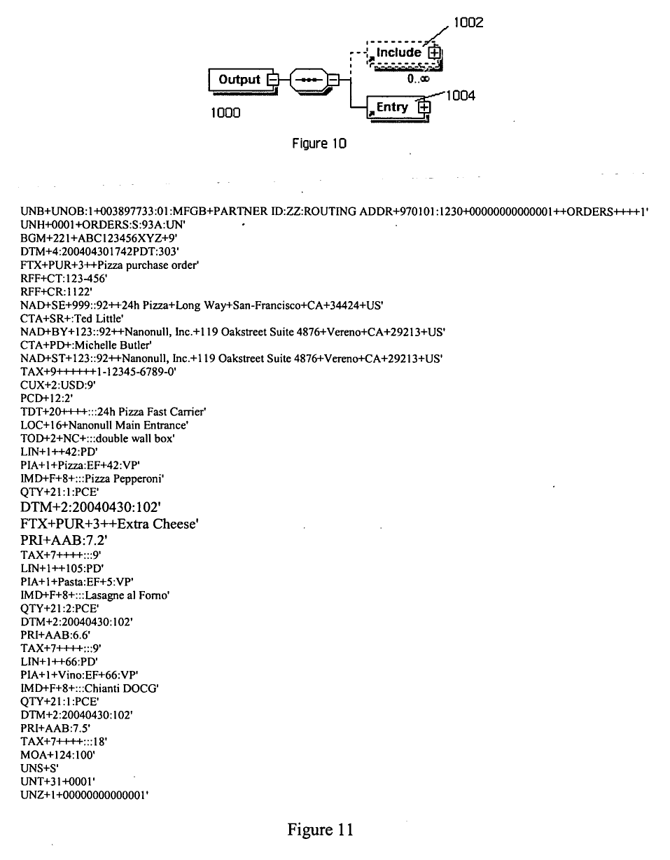

The XML schema defining the format of the external files preferably includes a set of Elements, and a set of Complex types. The elements preferably include data elements such as: Entry, Generator, Handler, Include, Output, Parser and Scanner. The Complex types preferably include such types as: ActionType, CommandType, ConditionsType, HandlerType, MetaType, ParserGeneralType, ParserType, and ScannerType. Each of these Elements and Complex types are described in more detail below. The Generator element has associated child elements, as illustrated in FIG. 6. As will be seen, the Generator element defines the configuration file data structure for generalized text file access. As illustrated in FIG. 6, the Generator element 600 preferably includes four (4) child elements: Meta element 602, Scanner element 604, Parser element 606, and Output element 608. The Meta element is illustrated in FIG. 7 as reference numeral 700 and includes a set of children: Type 702, Info 704 and Agency 706. The Scanner element is illustrated in FIG. 8 as reference numeral 800 and includes a separator element 802. The Parser element is illustrated in FIG. 9 as reference numeral 900 and also includes a set of children: General 902, Handlers 904 and Functions 906. The Output element is illustrated in FIG. 10 as reference numeral 1000 and has the Include element 1002 and Entry element 1004 as children. In the context of FIG. 5, once the file data is entered, the configuration file 502 comprises the Generator element and its associated children. Preferably, the structure file 504 is described by the Generator element and its associated Output element. Preferably, the control file 506 is described by the Generator element and its Parser element.

The following provides a more comprehensive description of the XML schema (called Config.xsd) comprising the various Elements and Complex types, as well as each of their associated children, attributes, properties, and XML source, as the case may be.

Schema Config.xsd

| | |
|---|---|
| attribute form default: | unqualified |
| element form default: | qualified |

| Elements | Complex types |
|---|---|
| Entry | ActionType |
| Generator | CommandType |
| Handler | ConditionsType |
| Include | HandlerType |
| Output | MetaType |
| Parser | ParserGeneralType |
| Scanner | ParserType |
| | ScannerType |

Element Entry

| properties | content complex | | | |
|---|---|---|---|---|
| children | Entry | | | |
| used by | elements Entry Output | | | |
| attributes | Name | Type | Use | Default |

| | | |
|---|---|---|
| Name | xs:string | required |
| Type | xs:token | optional |

| | | |
|---|---|---|
| Repeat | xs:long | 1 |
| Option | | |
| MaximalLength | xs:long | 1 |
| Class | | |
| Info | xs:string | |
| Native | xs:string | |

| | |
|---|---|
| source | <xs:element name=“Entry”> |

<xs:complexType>

<xs:sequence>

<xs:element ref=“Entry” minOccurs=“0”
maxOccurs=“unbounded”/>

</xs:sequence>
<xs:attribute name=“Name” type=“xs:string”
use=“required”/>
<xs:attribute name=“Type” type=“xs:token”
use=“optional”/>
<xs:attribute name=“Repeat” type=“xs:long”
default=“1”/>
<xs:attribute name=“Option”>

<xs:simpleType>

<xs:restriction base=“xs:string”>

<xs:length value=“1”/>
<xs:pattern value=“M”/>
<xs:pattern value=“C”/>

</xs:restriction>

</xs:simpleType>

</xs:attribute>
<xs:attribute name=“Maximal Length”
type=“xs:long” default=“1”/>
<xs:attribute name=“Class”>

<xs:simpleType>

<xs:restriction base=“xs:string”>

<xs:pattern value=“DataElement”/>
<xs:pattern value=“Composite”/>
<xs:pattern value=“Segment”/>
<xs:pattern value=“Group”/>

</xs:restriction>

</xs:simpleType>

</xs:attribute>
<xs:attribute name=“Info” type=“xs:string”/>
<xs:attribute name=“Native” type=“xs:string”/>

</xs:complexType>

</xs:element>

element Generator

| properties | content complex |
|---|---|
| children | Meta Scanner Parser Output |
| annotation | documentation Configuration file data structure for |
| | generalized Text file access in MapForce |
| source | <xs:element name=“Generator”> |

<xs:annotation>

<xs:documentation>Configuration file data
structure for generalized Text file access in

MapForce</xs:documentation>

</xs:annotation>
<xs:complexType>

<xs:sequence>

<xs:element name=“Meta” type=“MetaType”
minOccurs=“0”/>
<xs:element ref=“Scanner” minOccurs=“0”/>
<xs:element ref=“Parser” minOccurs=“0”/>
<xs:element ref=“Output” minOccurs=“0”/>

</xs:sequence>

</xs:complexType>

</xs:element>

element Generator/Meta

| | |
|---|---|
| type | MetaType |
| properties | isRef 0 |
| | content complex |
| children | Type Info Agency |
| source | <xs:element name=“Meta” type=“MetaType” |
| | minOccurs=“0”/> |

element Handler

| type | HandlerType | | | |
|---|---|---|---|---|
| properties | content complex | | | |
| children | Commands | | | |
| used by | elements ParserType/Functions ParserType/Handlers | | | |
| attributes | Name | Type | Use | Default |
| | Name | xs:token | required | |

| | |
|---|---|
| source | <xs:element name=“Handler” type=“HandlerType”/> |

element Output

| | |
|---|---|
| properties | content complex |
| children | Include Entry |
| used by | element Generator |
| source | <xs:element name=“Output”> |

<xs:complexType>

<xs:sequence>

<xs:element ref=“Include” minOccurs=“0”
maxOccurs=“unbounded”/>
<xs:element ref=“Entry”/>

</xs:sequence>

</xs:complexType>

</xs:element>

element Parser

| | |
|---|---|
| type | ParserType |
| properties | content complex |
| children | General Handlers Functions |
| used by | element Generator |
| source | <xs:element name=“Parser” type=“ParserType”/> |

element Scanner

| | |
|---|---|
| type | ScannerType |
| properties | content complex |
| children | Separator |
| used by | element Generator |
| source | <xs:element name=“Scanner” type=“ScannerType”/> |

complexType ActionType

| used by | elements | CommandType/BackCharacter | | |
|---|---|---|---|---|
| | | CommandType/CallHandler | | |
| | | CommandType/EnterHierarchy | | |
| | | CommandType/EscapeCharacter | | |
| | | CommandType/IgnoreCharacter | | |
| | | CommandType/IgnoreValue | | |
| | | CommandType/LeaveHierarchy | | |
| | | CommandType/SeparatorCharacter | | |
| | | CommandType/StoreCharacter | | |
| | | CommandType/StoreValue | | |
| attributes | Name | Type | Use | Default |

| | | |
|---|---|---|
| Name | xs:string | required |

| | |
|---|---|
| annotation | documentation Base Type for all actions |
| source | <xs:complexType name=“ActionType”> |

<xs:annotation>

<xs:documentation>Base Type for all
actions</xs:documentation>

</xs:annotation>
<xs:attribute name=“Name” type=“xs:string”
use=“required”/>

</xs:complexType>

complexType CommandType

| children | EnterHierarchy CallHandler IgnoreValue IgnoreCharacter StoreValue StoreCharacter EscapeCharacter |
|---|---|
| | SeparatorCharacter BackCharacter WhileLoop Commands LeaveHierarchy |
| used by | elements HandlerType/Commands CommandType/WhileLoop/Commands |
| annotation | documentation Collection of available commands |
| source | <xs:complexType name=“CommandType”> |

<xs:annotation>

<xs:documentation>Collection of available commands</xs:documentation>

</xs:annotation>
<xs:sequence maxOccurs=“unbounded”>

<xs:choice maxOccurs=“unbounded”>

<xs:element name=“EnterHierarchy” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>

</xs:extension>

</xs:complexContent>

</xs:complexType>

</xs:element>
<xs:element name=“CallHandler” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>

</xs:extension>

</xs:complexContent>

</xs:complexType>

</xs:element>
<xs:element name=“IgnoreValue” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>

</xs:extension>

</xs:complexContent>

</xs:complexType>

</xs:element>
<xs:element name=“IgnoreCharacter” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>

</xs:extension>

</xs:complexContent>

</xs:complexType>

</xs:elements
<xs:element name=“StoreValue” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>
<xs:element name=“Decoder” minOccurs=“0”>

<xs:complexType>

<xs:sequence>

<xs:element name=“Decode” maxOccurs=“unbounded”>

<xs:complexType>

<xs:complexContent>

<xs:extension base=“xs:anyType”>

<xs:attribute name=“Content” type=“xs:anySimpleType”

use=“required”/>

<xs:attribute name=“Value” type=“xs:anySimpleType”

use=“required”/>

</xs:extension>

</xs:complexContent>

</xs:complexType>

</xs:element>

</xs:sequence>
<xs:attribute name=“Name” type=“xs:string” use=“optional”/>
<xs:attribute name=“Type” type=“xs:string” use=“optional”/>

</xs:complexType>

</xs:element>

</xs:sequence>
<xs:attribute name=“Type” type=“xs:string” use=“optional”/>

</xs:extension>

</xs:complexContent>

</xs:complexType>

</xs:element>
<xs:element name=“StoreCharacter” minOccurs=“0” maxOccurs=“unbounded”>

<xs:complexType>

<xs:complexContent>
<xs:extension base=“ActionType”>

<xs:sequence>

<xs:element name=“Conditions” type=“ConditionsType” minOccurs=“0”/>

</xs:sequence>
<xs:attribute name=“Type” type=“xs:string” use=“optional”/>

</xs:extension>

</xs:complexContent>

</xs:complexType>

</xs:element>
<xs:element name=“EscapeCharacter” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequences
<xs:attribute name=“Type” type=“xs:string” use=“optional”/>

</xs:extension>

</xs:complexContent>

</xs:complexType>

</xs:element>
<xs:element name=“SeparatorCharacter” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>
<xs:attribute name=“Type” type=“xs:string” use=“optional”/>

</xs:extension>

</xs:complexContent>

</xs:complexType>

</xs:element>
<xs:element name=“BackCharacter” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>
<xs:attribute name=“Type” type=“xs:string” use=“optional”/>

</xs:extension>

</xs:complexContent>

</xs:complexType>

</xs:element>
<xs:element name=“WhileLoop” minOccurs=“0” maxOccurs=“unbounded”>

<xs:complexType>

<xs:sequence>

<xs:element name=“Commands” type=“CommandType” minOccurs=“0”

maxOccurs=“unbounded”/>

</xs:sequence>
<xs:attribute name=“Count” type=“xs:positiveInteger” use=“optional”/>

</xs:complexType>

</xs:element>
<xs:element name=“Commands” minOccurs=“0” maxOccurs=“unbounded”/>
<xs:element name=“LeaveHierarchy” minOccurs=“0” maxOccurs=“unbounded”>

<xs:complexType>

<xs:complexContent>

<xs:extension base=“ActionType”>

<xs:sequence>

<xs:element name=“Conditions” type=“ConditionsType” minOccurs=“0”/>

</xs:sequence>

</xs:extension>

</xs:complexContent>

</xs:complexType>

</xs:element>

</xs:choice>

</xs:sequence>

</xs:complexType>

element CommandType/EnterHierarchy

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |

| source | <xs:element name=“EnterHierarchy” minOccurs=”0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>

</xs:extension>

</xs:complexContent>

</xs:complexType>

</xs:element>

element CommandType/EnterHierarchy/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/CallHandler

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |

| source | <xs:element name=“CallHandler” minOccurs=“0” |
|---|---|
| | maxOccurs=“unbounded”> |

<xs:complexType>

<xs:complexContent>

<xs:extensionbase=“ActionType”>

<xs:sequence>

<xs:element name=“Conditions”
type=“ConditionsType”
minOccurs=“0”/>

</xs:sequence>

</xs:extension>

</xs:complexContent>

</xs:complexType>

</xs:element>

element CommandType/CallHandler/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/IgnoreValue

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |

| source | <xs:element name=“IgnoreValue” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>

</xs:extension>

</xs:complexContent>

</xs:complexType>

</xs:element>

element CommandType/IgnoreValue/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/IgnoreCharacter

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |

| source | <xs:element name=“IgnoreCharacter” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>

</xs:extension>

</xs:complexContent>

</xs:complexType>

</xs:element>

element CommandType/IgnoreCharacter/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/StoreValue

| type | extension of ActionType | | | |
|---|---|---|---|---|
| properties | isRef 0 | | | |
| | content complex | | | |
| children | Conditions Decoder | | | |
| attributes | Name | Type | Use | Default |

| | | |
|---|---|---|
| Name | xs:string | required |
| Type | xs:string | optional |

| | |
|---|---|
| source | <xs:element name=“StoreValue” minOccurs=“0” maxOccurs=“unbounded”> |

<xs:complexType>

<xs:complexContent>

<xs:extension base=“ActionType”>

<xs:sequence>

<xs:element name=“Conditions” type=“ConditionsType” minOccurs=“0”/>
<xs:element name=“Decoder” minOccurs=“0”>

<xs:complexType>

<xs:sequence>

<xs:element name=“Decode” maxOccurs=“unbounded”>

<xs:complexType>

<xs:complexContent>

<xs:extension base=“xs:anyType”>

<xs:attribute name=“Content” type=“xs:anySimpleType”

use=“required”/>

<xs:attribute name=“Value” type=“xs:anySimpleType” use=“required”/>

</xs:extension>

</xs:complexContent>

</xs:complexType>

</xs:element>

</xs:sequence>
<xs:attribute name=“Name” type=“xs:string” use=“optional”/>
<xs:attribute name=“Type” type=“xs:string” use=“optional”/>

</xs:complexType>

</xs:element>

</xs:sequence>
<xs:attribute name=“Type” type=“xs:string” use=“optional”/>

</xs:extension>

</xs:complexContent>

</xs:complexType>

</xs:element>

element CommandType/StoreValue/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/StoreValue/Decoder

| properties | isRef 0 | | | |
|---|---|---|---|---|
| | content complex | | | |
| children | Decode | | | |
| attributes | Name | Type | Use | Default |

| | | |
|---|---|---|
| Name | xs:string | optional |
| Type | xs:string | optional |

| | |
|---|---|
| source | <xs:element name=“Decoder” minOccurs=“0”> |

<xs:complexType>

<xs:sequence>

<xs:element name=“Decode”
maxOccurs=“unbounded”>

<xs:complexType>

<xs:complexContent>

<xs:extension
base=“xs:anyType”>

<xs:attribute
name=“Content”
type=“xs:anySimpleType”
use=“required”/>
<xs:attribute name=“Value”
type=“xs:anySimpleType”
use=“required”/>

</xs:extension>

</xs:complexContent>

</xs:complexType>

</xs:element>

</xs:sequence>
<xs:attribute name=“Name” type=“xs:string”
use=“optional”/>
<xs:attribute name=“Type” type=“xs:string”
use=“optional”/>

</xs:complexType>

</xs:element>

element CommandType/StoreValue/Decoder/Decode

| type | extension of xs:anyType | | | |
|---|---|---|---|---|
| properties | isRef 0 | | | |
| | content complex | | | |
| attributes | Name | Type | Use | Default |

| | | |
|---|---|---|
| Content | xs:anySimpleType | required |
| Value | xs:anySimpleType | required |

| | |
|---|---|
| source | <xs:element name=“Decode” maxOccurs=“unbounded”> |

<xs:complexType>

<xs:complexContent>

<xs:extension base=“xs:anyType”>

<xs:attribute name=“Content”
type=“xs:anySimpleType”
use=“required”/>
<xs:attribute name=“Value”
type=“xs:anySimpleType”
use=“required”/>

</xs:extension>

</xs:complexContent>

</xs:complexType>

</xs:element>

element CommandType/StoreCharacter

| | |
|---|---|
| type | extension of ActionType |
| properties | isRef 0 |

| | |
|---|---|
| content complex | |
| children | Conditions |

| | | | | |
|---|---|---|---|---|
| attributes | Name | Type | Use | Default |

| | | |
|---|---|---|
| Name | xs:string | required |
| Type | xs:string | optional |

| source | <xs:element name=“StoreCharacter” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>
<xs:attribute name=“Type”
type=“xs:string”
use=“optional”/>

</xs:extension>

</xs:complexContent>

</xs:complexType>

</xs:element>

element CommandType/StoreCharacter/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/EscapeCharacter

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |
| Type | xs:string | optional |

| source | <xs:element name=“EscapeCharacter” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>
<xs:attribute name=“Type”
type=“xs:string”
use=“optional”/>

</xs:extension>

</xs:complexContent>

</xs:complexType>

</xs:element>

element CommandType/EscapeCharacter/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/SeparatorCharacter

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |
| Type | xs:string | optional |

| source | <xs:element name=“SeparatorCharacter” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>
<xs:attribute name=“Type”
type=“xs:string”
use=“optional”/>

</xs:extension>

</xs:complexContent>

</xs:complexType>

</xs:element>

element CommandType/SeparatorCharacter/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/BackCharacter

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |
| Type | xs:string | optional |

| source | <xs:element name=“BackCharacter” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>
<xs:attribute name=“Type”
type=“xs:string”
use=“optional”/>

</xs:extension>

</xs:complexContent>

</xs:complexType>

</xs:element>

element CommandType/BackCharacter/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

element CommandType/WhileLoop

| properties | isRef 0 | | | |
|---|---|---|---|---|
| | content complex | | | |
| children | Commands | | | |
| attributes | Name | Type | Use | Default |

| | | |
|---|---|---|
| Count | xs:positiveInteger | optional |

| source | <xs:element name=“WhileLoop” minOccurs=“0” |
|---|---|
| | maxOccurs=“unbounded”> |

<xs:complexType>

<xs:sequence>

<xs:element name=“Commands”
type=“CommandType” minOccurs=“0”
maxOccurs=“unbounded”/>
</xs:sequence>

<xs:attribute name=“Count”
type=“xs:positiveInteger”
use=“optional”/>

</xs:complexType>

</xs:element>

element CommandTypeNwhileLoop/Commands

| | |
|---|---|
| type | CommandType |
| properties | isRef 0 |
| | content complex |
| children | EnterHierarchy CallHandler IgnoreValue IgnoreCharacter |
| | StoreValue StoreCharacter EscapeCharacter |
| | SeparatorCharacter BackCharacter WhileLoop Commands |
| | LeaveHierarchy |
| source | <xs:element name=“Commands” type=“CommandType” |
| | minOccurs=“0” maxOccurs=“unbounded”/> |

element CommandType/Commands

| | |
|---|---|
| properties | isRef 0 |
| source | <xs:element name=“Commands” minOccurs=“0” |
| | maxOccurs=“unbounded”/> |

element CommandType/LeaveHierarchy

| type | extension of ActionType | | | |
|---|---|---|---|---|
| properties | isRef 0 | | | |
| | content complex | | | |
| children | Conditions | | | |
| attributes | Name | Type | Use | Default |

| | | |
|---|---|---|
| Name | xs:string | required |

| source | <xs:element name=“LeaveHierarchy” minOccurs=“0” |
|---|---|
| | maxOccurs=“unbounded”> |

<xs:complexType>

<xs:complexContent>

<xs:extension base=“ActionType”>

<xs:sequence>

<xs:element name=“Conditions”
type=“ConditionsType”
minOccurs=“0”/>

</xs:sequence>

</xs:extension>

</xs:complexContent>

</xs:complexType>

</xs:element>

element CommandType/LeaveHierarchy/Conditions

| type | ConditionsType | | | |
|---|---|---|---|---|
| properties | isRef 0 | | | |
| | content complex | | | |
| children | Condition | | | |
| attributes | Name | Type | Use | Default |
| | Operation | | optional | Or |

| | |
|---|---|
| source | <xs:element name=“Conditions” type=“ConditionsType” |
| | minOccurs=“0”/> |

complexType ConditionsType

| children | Condition | | | |
|---|---|---|---|---|
| used by | elements | CommandType/EnterHierarchy/Conditions | | |
| | | CommandType/CallHandler/Conditions | | |
| | | CommandType/IgnoreValue/Conditions | | |
| | | CommandType/IgnoreCharacter/Conditions | | |
| | | CommandType/StoreValue/Conditions | | |
| | | CommandType/StoreCharacter/Conditions | | |
| | | CommandType/EscapeCharacter/Conditions | | |
| | | CommandType/SeparatorCharacter/Conditions | | |
| | | CommandType/BackCharacter/Conditions | | |
| | | CommandType/LeaveHierarchy/Conditions | | |
| attributes | Name | Type | Use | Default |

| | | |
|---|---|---|
| Operation | optional | Or |

| | |
|---|---|
| annotation | documentation Defines a collection of conditions |
| source | <xs:complexType name=“ConditionsType”> |

<xs:annotation>

<xs:documentation>Defines a collection of
conditions</xs:documentation>

</xs:annotation>
<xs:sequence>

<xs:element name=“Condition”
maxOccurs=“unbounded”>

<xs:complexType>

<xs:attribute name=“CurrentSeparator”
type=“xs:string” use=“optional”/>
<xs:attribute name=“CurrentValue”
type=“xs:string” use=“optional”/>
<xs:attribute name=“OutputParentExist”
type=“xs:string” use=“optional”/>
<xs:attribute name=“OutputSiblingExist”
type=“xs:string” use=“optional”/>

</xs:complexType>

</xs:element>

</xs:sequence>
<xs:attribute name=“Operation” use=“optional”
default=“Or”>

<xs:simpleType>

<xs:restriction base=“xs:QName”>

<xs:enumeration value=“Or”/>
<xs:enumeration value=“And”/>

</xs:restriction>

</xs:simpleType>

</xs:attribute>

</xs:complexType>

element ConditionsType/Condition

| properties | isRef 0 | | | |
|---|---|---|---|---|
| | content complex | | | |
| attributes | Name | Type | Use | Default |

| | | |
|---|---|---|
| CurrentSeparator | xs:string | optional |
| CurrentValue | xs:string | optional |
| OutputParentExist | xs:string | optional |
| OutputSiblingExist | xs:string | optional |

| | |
|---|---|
| source | <xs:element name=“Condition” maxOccurs=“unbounded”> |

<xs:complexType>

<xs:attribute name=“CurrentSeparator”
type=“xs:string” use=“optional”/>

<xs:attribute name=“CurrentValue”
type=“xs:string” use=“optional”/>
<xs:attribute” name=“OutputParentExist”
type=“xs:string” use=“optional”/>
<xs:attribute name=“OutputSiblingExist”
type=“xs:string” use=“optional”/>

</xs:complexType>

</xs:element>

complexType HandlerType

| children | Commands | | | |
|---|---|---|---|---|
| used by | elements ParserGeneralType/Epilog Handler | | | |
| | ParserGeneralType/Prolog | | | |
| attributes | Name | Type | Use | Default |

| | | |
|---|---|---|
| Name | xs:token | required |

| annotation | documentation Specify a handler routine for a key or a |
|---|---|
| | subroutine that can be invoked from other handlers |
| source | <xs:complexType name=“HandlerType”> |

<xs:annotation>

<xs:documentation>Specify a handler routine for
a key or a subroutine that can be invoked from
other handlers</xs:documentation>

</xs:annotation>
<xs:sequence>

<xs:element name=“Commands”
type=“CommandType”/>

</xs:sequence>
<xs:attribute name=“Name” type=“xs:token”
use=“required”/>

</xs:complexType>

element HandlerType/Commands

| | |
|---|---|
| type | CommandType |
| properties | isRef 0 |
| | content complex |
| children | EnterHierarchy CallHandler IgnoreValue IgnoreCharacter |
| | StoreValue StoreCharacter EscapeCharacter |
| | SeparatorCharacter BackCharacter WhileLoop Commands |
| | LeaveHierarchy |
| source | <xs:element name =“Commands” |
| | type=“CommandType”/> |

complexType MetaType

diagram

| | |
|---|---|
| children | Type Info Agency |
| used by | element Generator/Meta |
| source | <xs:complexType name=“MetaType”> |

<xs:sequence>

<xs:element name=“Type” type=“xs:string”>

<xs:annotation>

<xs:documentation>The message
type/name</xs:documentation>

</xs:annotation>

</xs:element>
<xs:element name=“Info” type=“xs:string”
minOccurs=“0”>

<xs:annotation>

<xs:documentation>Description
text</xs:documentation>

</xs:annotation>

</xs:element>
<xs:element name =“Agency” type=“xs:string”
minOccurs=“0”>

<xs:annotation>

<xs:documentation>Type of the message
(EDIFACT / X12)</xs:documentation>

</xs:annotation>

</xs:element>

</xs:sequence>

</xs:complexType>

element MetaType/Type

| type | xs:string |
|---|---|
| properties | isRef 0 |
| | content simple |
| annotation | documentation The message type/name |
| source | <xs:element name=“Type” type=“xs:string”> |

<xs:annotation>

<xs:documentation>The message
type/name</xs:documentation>

</xs:annotation>

</xs:element>

element MetaType/Info

| type | xs:string |
|---|---|
| properties | isRef 0 |
| | content simple |
| annotation | documentation Description text |
| source | <xs:element name=“Info” type=“xs:string” |

minOccurs=“0”>

<xs:annotation>

<xs:documentation>Description
text</xs:documentation>

</xs:annotation>

</xs:element>

element MetaType/Agency

| type | xs:string |
|---|---|
| properties | isRef 0 |
| | content simple |
| annotation | documentation Type of the message (EDIFACT/X12) |
| source | <xs:element name=“Agency” type=“xs:string” |
| | minOccurs=“0”> |

<xs:annotation>

<xs:documentation>Type of the message
(EDIFACT / X12)</xs:documentation>

</xs:annotation>

</xs:element>

complexType ParserGeneralType

| | |
|---|---|
| children | Prolog Epilog Decoder |
| used by | element ParserType/General |
| annotation | documentation General settings for the Parser |
| source | <xs:complexType name=“ParserGeneralType”> |

<xs:annotation>

<xs:documentation>General settings for the
Parser</xs:documentation>

</xs:annotation>
<xs:sequence minOccurs=“0”>

<xs:element name=“Prolog” type=“HandlerType”
minOccurs=“0”/>
<xs:element name=“Epilog” type=“HandlerType”
minOccurs=“0”/>
<xs:element name=“Decoder” type=“xs:anyURI”
minOccurs=“0”/>

</xs:sequence>

</xs:complexType>

element ParserGeneralType/Prolog

| type | HandlerType | | | |
|---|---|---|---|---|
| properties | isRef 0 | | | |
| | content complex | | | |
| children | Commands | | | |
| attributes | Name | Type | Use | Default |
| | Name | xs:token | required | |

| | |
|---|---|
| source | <xs:element name=“Prolog” type=“HandlerType” |
| | minOccurs=“0”/> |

element ParserGeneraIType/Epilog

| type | HandlerType | | | |
|---|---|---|---|---|
| properties | isRef 0 | | | |
| | content complex | | | |
| children | Commands | | | |
| attributes | Name | Type | Use | Default |
| | Name | xs:token | required | |

| | |
|---|---|
| source | <xs:element name=“Epilog” type=“HandlerType” |
| | minOccurs=“0”/> |

element ParserGeneralType/Decoder

| | |
|---|---|
| type | xs:anyURI |
| properties | isRef 0 |
| | content simple |
| source | <xs:element name=“Decoder” type=“xs:anyURI” |
| | minOccurs=“0”/> |

complexType ParserType

| | |
|---|---|
| children | General Handlers Functions |
| used by | element Parser |
| annotation | documentation Configuration for the Parser |
| source | <xs:complexType name=“ParserType”> |

<xs:annotation>

<xs:documentation>Configuration for the
Parser</xs:documentation>

</xs:annotation>
<xs:sequence>

<xs:element name=“General”
type=“ParserGeneralType” minOccurs=“0”/>
<xs:element name=“Handlers”>

<xs:complexType>

<xs:sequence>

<xs:element ref=“Include”
minOccurs=“0”
maxOccurs=“unbounded”/>
<xs:element ref=“Handler”
minOccurs=“0”
maxOccurs=“unbounded”/>

</xs:sequence>

</xs:complexType>

</xs:element>
<xs:element name=“Functions”>

<xs:complexType>

<xs:sequence>

<xs:element ref=“Include”
minOccurs=“0”
maxOccurs=“unbounded”/>
<xs:element ref=“Handler”
minOccurs=“0”
maxOccurs=“unbounded”/>

</xs:sequence>

</xs:complexType>

</xs:element>

</xs:sequence>

</xs:complexType>

element ParserType/General

| | |
|---|---|
| type | ParserGeneralType |
| properties | isRef 0 |
| | content complex |
| children | Prolog Epilog Decoder |
| source | <xs:element name=“General” type=“ParserGeneralType” |
| | minOccurs=“0”/> |

element ParserType/Handlers

| properties | isRef 0 |
|---|---|
| | content complex |
| children | Include Handler |
| source | <xs:element name=“Handlers”> |

<xs:complexType>

<xs:sequence>

<xs:element ref=“Include” minOccurs=“0”
maxOccurs=“unbounded”/>
<xs:element ref=“Handler” minOccurs=“0”
maxOccurs=“unbounded”/>

</xs:sequence>

</xs:complexType>

</xs:element>

element ParserType/Functions

| properties | isRef 0 |
|---|---|
| | content complex |
| children | Include Handler |
| source | <xs:element name=“Functions”> |

<xs:complexType>

<xs:sequence>

<xs:element ref=“Include” minOccurs=“0”
maxOccurs=“unbounded”/>
<xs:element ref=“Handler” minOccurs=“0”
maxOccurs=”unbounded”/>

</xs:sequence>

</xs:complexType>

</xs:element>

complexType ScannerType

| | |
|---|---|
| children | Separator |
| used by | element Scanner |
| annotation | documentation Configuration for the Scanner |
| source | <xs:complexType name=“ScannerType”> |

<xs:annotation>

<xs:documentation>Configuration for the
Scanner</xs:documentation>

</xs:annotation>
<xs:sequence>

<xs:element name=“Separator”
maxOccurs=“unbounded”>

<xs:complexType>

<xs:attribute name=“Name”
use=“required”>

<xs:simpleType>

<xs:restriction
base=“xs:string”>

<xs:whiteSpace
value=“preserve”/>

</xs:restriction>

</xs:simpleType>

</xs:attribute>
<xs:attribute name=“Token”
type=“xs:string” use=“required”/>

</xs:complexType>

</xs:element>

</xs:sequence>

</xs:complexType>

element ScannerType/Separator

| properties | isRef 0 | | | |
|---|---|---|---|---|
| | content complex | | | |
| attributes | Name | Type | Use | Default |

| Name | | required |
|---|---|---|
| Token | xs:string | required |

| | |
|---|---|
| source | <xs:element name=“Separator” maxOccurs=“unbounded”> |

<xs:complexType>

<xs:attribute name=“Name” use=“required”>

<xs:simpleType>

<xs:restriction base=“xs:string”>

<xs:whiteSpace value=“preserve”/>

</xs:restriction>

</xs:simpleType>

</xs:attribute>
<xs:attribute name=“Token” type=“xs:string”
use=“required”/>

</xs:complexType>

</xs:element>

The above XML schema describes the structure of the external (the configuration, structure and control) files, while the contents of those three (3) files describe the actual structure of the particular text file format. More generally, the XML schema describes the structure of the structure that describes the text file format. And, in a particular embodiment, the external files define what data is contained in the text file, how it is structured and what type of data it is, and how that description can be used to transform the text file into other data formats, or to transform other data into the text file according to the described format.

The text file schema of the invention provides several important advantages. In the first instance, the schema (by and through the associated external files) provide a convenient way to represent or impose a “structure” upon text files that otherwise have little or no structure. Import or export functions are controlled by the external files and need not be directly written into an application. The user thus has the ability to control import or export functions directly. In addition, the external files can be generated automatically from standards documents (e.g., UN/EDIFACT, X12, or the like) and thus more readily bundled with data integration tools. A data integration tool that includes this functionality can thus provide EDI mapping support for any number of text message formats covered by existing (e.g., such as the EDIFACT) or later developed standards. The unique capability to easily integrate standards-based (or other) EDI data allows organizations to leverage investments in EDI technology and combine their EDI data with universal formats like XML, flat files, and databases. Indeed, the ability to open the EDI model to Internet-based e-commerce and relational database stores allows businesses of any size to obtain the benefits of real-time information exchange.

The schema is easy to use and provides support for all possible text files. As noted above, the schema enables native support for standards-based text formats but also allows a user to extend the system (e.g., through the display panels of FIGS. 3A and 3B) for any other file format. The schema facilitates both for input (data transformation from text file format into XML and databases) and output (data transformation from XML and databases to such text file formats). Because the external files are XML, they are easily extensible using existing XML tools. Using the display tools, the external files may be annotated or extended easily to enable the user to provide comments on every field or structure element. The external files also can be used for input and output validation.

According to the present invention, the data processing system includes software code executable by a processor for describing a text file format into the set of external files (e.g., the configuration file, the structure file and the control file) according to the given XML schema that has been described. As noted above, as used herein, the configuration file, structure file and control file may be separate files or separate portions of the same file. More generally, the external files comprise one or more XML files (or portions thereof) that include the configuration, structure and control XML-formatted data, as has been described. Thus, as used herein, the term “file” (e.g., in the context of an external file) should be broadly construed to cover an actual file, a portion of an actual file, a dataset, or any other known or later-developed construct for supporting the configuration, structure or control data, as the case may be. The external files are very advantageous, because once these files have been defined for a given text file format, the same files can be used to import text files based on the format, to export to new text files in that format, and to validate the contents of such text files so that they can be processed correctly.

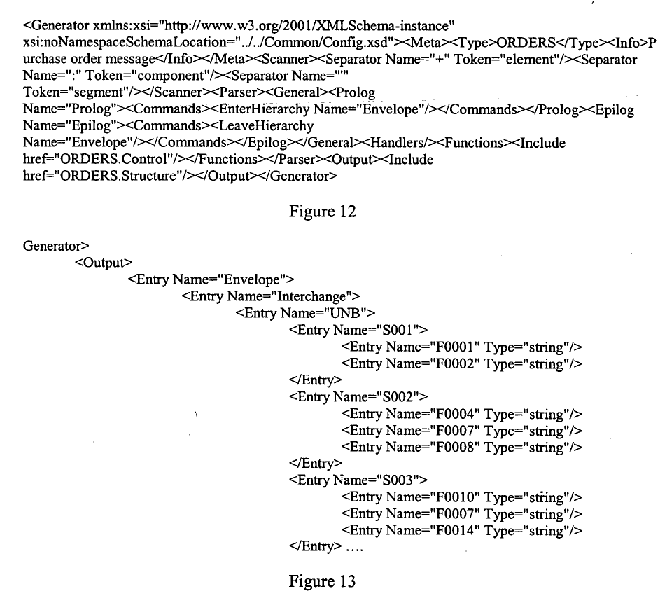

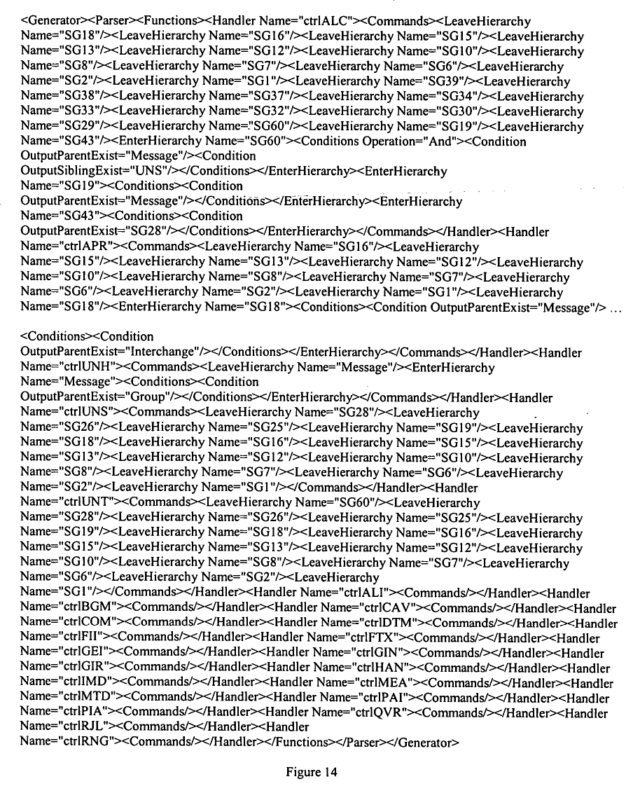

As a representative example, FIG. 11 illustrates an EDI document order, together with the configuration file (FIG. 12), structure file (FIG. 13) and control file (FIG. 14) generated therefrom according to the schema of the present invention. As can be seen, the configuration file generally defines what data is contained in the text file, and the structure and control files describe how the text file is structured and what type of data it is, as well as how that description can be used to transform the text file into other data formats, and vice versa.

As a variant, a user interface (UI) tool may be provided that allows a user to define flexible text file transformations directly, e.g., by visually pointing to elements in a text file and having the external files created automatically.

Having thus described our invention, what we claim is set forth below.

1. A method of data integration, comprising:
describing a text file format in an alternative structured representation, wherein the alternative representation conforms to a given schema that defines what data is contained in the text file, how the text file is structured, and how the text file can be transformed into at least one other non text file format; and
using the alternative representation in a given data integration function.

2. The method as described in claim 1 wherein the alternative structured representation is a set of external files.

3. The method as described in claim 2 wherein the set of external files comprise a first file that describes a configuration of the text file according to the given schema, a second file that describes an output structure of the text file according to the given schema, and a third file that describes how to parse the text file according to the given schema.

4. The method as described in claim 3 wherein the external files are XML files.

5. The method as described in claim 1 wherein the given data integration function is selected from a set of functions: mapping a flat file to XML or a database, and mapping XML or a database to a flat file.

6. The method as described in claim 1 wherein the other non text file format is XML.

7. The method as described in claim 1 wherein the other non text file format is a database.

8. A method for describing a text file, comprising:
organizing given data from the text file according to a given XML schema; and
generating a set of external files that together comprise an alternative structured representation of the text file.

9. The method as described in claim 8 wherein the set of external files comprise a first file that describes a configuration of the text file according to the XML given schema, a second file that describes an output structure of the text file according to the given XML schema, and a third file that describes how to parse the text file according to the given XML schema.

10. The method as described in claim 9 wherein each of the first, second and third files comprise a set of XML elements.

11. The method as described in claim 10 wherein the first file comprises a meta element, a scanner element, a parser element, and an output element.

12. The method as described in claim 10 wherein the second file comprises a generator element and an output element.

13. The method as described in claim 10 wherein the third file comprises a generator element and a parser element.

14. In a data integration tool having a design interface for mapping between pairs of data representations, the improvement comprising:
code executable by a processor for describing a text file format in an alternative structured representation, wherein the alternative representation conforms to a given schema that defines what data is contained in the text file, how the text file is structured, and how the text file can be transformed into at least one other non text file format; and
code executable by a processor for generating at least one display associated with the data integration tool by which a user may define a custom text file format.

15. In the data integration tool as described in claim 14 wherein at least one alternative structured representation is provided as a native component of the data integration tool.

16. In the data integration tool as described in claim 15 wherein the alternative structured representation is derived from a given standards-based text file message.
